(19) United States
(12) Patent Application Publication
(10) Pub. No.: US 2012/0198658 A1
(43) Pub. Date: Aug. 9, 2012

(54) ERGONOMIC APPARATUS HAVING AN ELONGATE MEMBER

(76) Inventors: Matthew Scott Graham, Noblesville, IN (US); Troy Daniel Mason, Brownsburg, IN (US); Lou B. Schiesz, Fishers, IN (US); Pam S. Schiesz, Fishers, IN (US)

(21) Appl. No.: 13/099,094

(22) Filed: May 2, 2011

Related U.S. Application Data
(60) Provisional application No. 61/330,372, filed on May 2, 2010.

(51) Int. Cl. B25G 1/10; B25G 1/04

(52) U.S. Cl. 16/429; 16/110.1; 16/430

(57) ABSTRACT

In one embodiment, an ergonomic apparatus includes a rod having a first end and a second end, a first gripping member coupled proximate the first end, an engagement member coupled to the second end and a second gripping member movably coupled to the rod between the first end and the second end.

### CROSS-REFERENCE TO RELATED APPLICATIONS

This application claims the benefit of U.S. Provisional Application No. 61/330,372 filed May 2, 2010, which is incorporated herein by reference in its entirety.

### TECHNICAL FIELD

Embodiments of the present invention relate generally to an ergonomic apparatus and, more particularly to an ergonomic apparatus having an elongate member.

### BACKGROUND

Providing an ergonomic apparatus for loading a brush (e.g., with paint) remains an area of interest. Some existing systems have various shortcomings relative to certain applications. Accordingly, there remains a need for further contributions in this area of technology.

### BRIEF DESCRIPTION OF THE FIGURES

FIG. 1 is a perspective view illustrating an ergonomic apparatus according to one embodiment of the present invention.

FIG. 2 is a partial cross-section view illustrating a selective anchoring mechanism according to one embodiment.

FIGS. 3 and 4 are cross-section views illustrating a selective anchoring mechanism according to some embodiments of the present invention.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

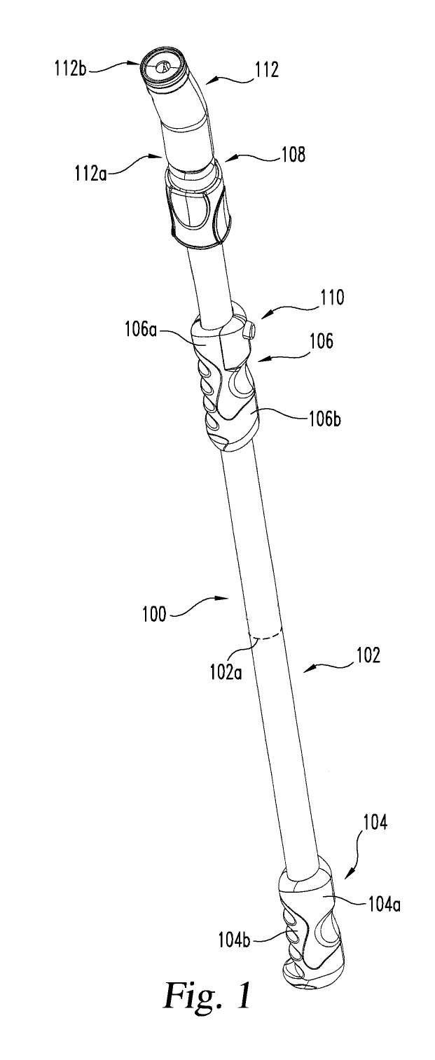

FIG. 1 is a perspective view illustrating an ergonomic apparatus according to one embodiment of the present invention.

Referring to FIG. 1, an ergonomic apparatus 100 may, for example, include an elongate member 102 (e.g., rod) and a first gripping portion 104, second gripping portion 106 and an engagement member 108, all coupled to the elongate member 102.

Elongate member 102 may be solid, hollow, or a combination thereof. When viewed along an axial direction, the elongate member 102 may have a cross-section that is circular, semi-circular, oval, hexagonal, or any other shape. In one embodiment, elongate member 102 has a fixed length along its longitudinal axis. In another embodiment, elongate member 102 has an adjustable length along its longitudinal axis. For example, elongate member 102 may be provided as a telescopic member having a plurality of sequentially-nested elongate segments that may be moved along a common longitudinal axis. In another example, elongate member 102 may be provided as a plurality of elongate segments end-to-end along a common longitudinal axis thereof. For example, the elongate member 102 may include two elongate segments joined together at 102a, where one elongate segment is coupled to an adjacent elongate segment by any suitable coupling mechanism (e.g., complementary threads, catch/latch system, spring-loaded detents, etc.). It will be appreciated that the elongate member 102 may be formed from more than two elongate segments coupled together. By adjusting the length of the elongate member 102, a user would be able to change the overall length of the ergonomic apparatus to gain access to hard-to-reach areas such as ceilings. Elongate member 102 may be formed from materials such as polymers, metals (e.g., aluminum), wood, composites, or the like or combinations thereof.

The first gripping member 104 is positioned at a first end of the elongate member 102 and is immovably coupled to elongate member 102. The first gripping member 104 may be coupled to the elongate member 102 by any suitable means (e.g., bolts, screws, adhesives, complementary threading with the elongate member 102, or the like or a combination thereof) so that the first gripping member 104 is at least substantially immobile relative to elongate member 102. Generally, the first gripping member 104 may be configured to be ergonomically held within the hand of a user. For example, the first gripping member 104 may include a plurality of finger-receiving contours and a palm-receiving contour to accommodate the fingers and the palm of a user's hand. The first gripping member 104 includes a first exterior surface 104a and a second exterior surface 104b. The palm-receiving contour may be located within the first exterior surface 104a and the finger-receiving contours may be located within the second exterior surface 104b. In one embodiment, the texture of the first exterior surface 104a is different from the texture of the second exterior surface 104b. For example, the second exterior surface 104b can be formed of a material such as a foam polymer or rubber for providing user comfort, while the first exterior surface 104a or the remainder of the first gripping portion 104 is formed of materials such as polymers, metals (e.g., aluminum), wood, composites, or the like or combinations thereof.

The second gripping member 106 is positioned between the first gripping member 104 and the engagement member 108. Like the first gripping member 104, the second gripping member 106 may be configured to be ergonomically held within the hand of a user. For example, the second gripping member 106 may include a plurality of finger-receiving contours and a palm-receiving contour to accommodate the fingers and the palm of a user's hand. Like the first gripping member 104, the second gripping member 106 may also include a first exterior surface 106a and a second exterior surface 106b within which the palm- and finger-receiving contours can be located. The first exterior surface 106a may be provided in the same manner, or in a different manner, from the first exterior surface 104a. Likewise, the second exterior surface 106b may be provided in the same manner, or in a different manner, from the first exterior surface 104a.

As exemplarily illustrated, the second gripping member 106 further includes a button 110 that can be selectively engaged (e.g., pressed) by the user to enable the second gripping member 106 to be movable relative to the elongate member 102. When the second gripping member 106 is movable relative to the elongate member 102, the second gripping member 106 can be moved lengthwise along the longitudinal axis of the elongate member 102, circumferentially about the longitudinal axis of the elongate member 102, or a combination thereof. In one embodiment, the second gripping member 106 is immovably coupled to the elongate member 102 unless the user engages the button 110.

The engagement member 108 is positioned at a second end of the elongate member 102 and is immovably coupled to elongate member 102. The engagement member 108 is configured to be coupled to an accessory so that it may be secured to the ergonomic apparatus 100. Exemplary accessories that may be received by the engagement member 108 include paint brushes, paint rollers, sponges, edgers, foam applicators, texturing applicators, cloth applicators, or the like, suitable for the application of liquids to an application surface. In one embodiment, accessories that may be received by the engagement member 108 can be provided as accessories such as those exemplarily described in copending U.S. patent application Ser. No. ______, filed May 2, 2011 and entitled “INTERFACE DEVICES AND METHODS OF USING THE SAME” (Attorney Docket No. MRGH-25), which is incorporated herein by reference in its entirety. As used herein, the term “liquid” can refer to paints, stains, washes, solvents, plasters, pastes and the like. As used herein, the term “application surface” can refer to drywall, doors, trim, cabinets, window frames, and the like.

In one embodiment, the engagement member 108 can be provided with an engagement portion or engagement mechanism as exemplarily described in copending U.S. patent application Ser. No. ______, filed May 2, 2011 and entitled “INTERFACE DEVICES AND METHODS OF USING THE SAME” (Attorney Docket No. MRGH-25), which is incorporated herein by reference in its entirety. Such engagement portions or engagement mechanisms may, in some embodiments, facilitate coupling of the engagement member 108 with an accessory. It will be appreciated, however, that an accessory may be coupled to the engagement member 108 in any desired manner.

FIG. 1 also illustrates a pivotal offset member 112 having a first portion 112a configured to be coupled to the engagement member 108 and a second portion 112b configured to be coupled to an accessory. The pivotal offset member 112 orients the accessory at an offset angle relative to the longitudinal axis of the elongate member 102. In one embodiment, the offset angle at which the pivotal offset member 112 orients an accessory is fixed. In another embodiment, the offset angle at which the pivotal offset member 112 orients an accessory can be adjustable. To provide the ability to adjust an offset angle, the pivotal offset member 112 can, for example, include a locking hinge (not shown) disposed between the first and second portions 112a and 112b. In one embodiment, the internal components of the pivotal offset member 112 may be provided as exemplarily described with respect to the adapter in the aforementioned copending U.S. patent application Ser. No. ______, filed May 2, 2011 entitled “INTERFACE DEVICES AND METHODS OF USING THE SAME” (Attorney Docket No. MRGH-25), which is incorporated herein by reference in its entirety.

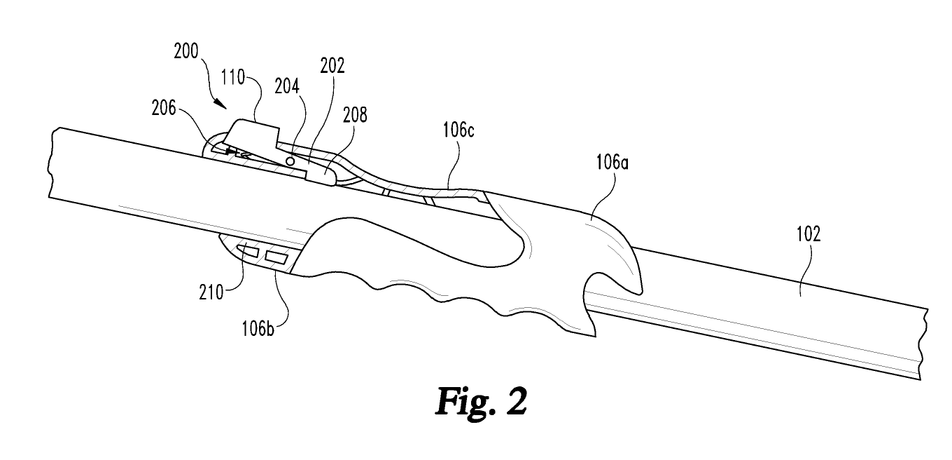

FIG. 2 is a partial cross-section view illustrating a selective anchoring mechanism according to one embodiment.

Referring to FIG. 2, the second gripping member 106 includes a selective anchoring mechanism 200 configured to movably or immovably couple the second gripping member 106 to the elongate member 102. As exemplarily shown, the selective anchoring mechanism 200 includes the aforementioned button 110 as well as a lever 202, pivot element 204, spring 206 and stopper 208.

The button 110 and stopper 208 are connected to opposite ends of the lever 202. The pivot element 204 is located between the button 110 and stopper 208 and may be connected to a complementary pivot element (not shown) connected to a housing 106c that provides the second exterior surface 106b. In one example, the pivot element 204 is a peg or pin extending away from the lever 202 and the complementary pivot element is a recess formed in the housing 106c that receives the peg or pin. In another example, the pivot element 204 is an aperture extending partially or completely through the lever 202 and the complementary pivot element is a peg or pin extending into the aperture.

A portion of the housing 106c also defines a sleeve 210 configured to receive the elongate member 102. The spring 206 is connected between the sleeve 210 and the button 110. When the button 110 is not engaged (e.g., pressed) by a user, the spring 206 biases the button 110 upward, causing the lever 202 to rotate about pivot element 204 and forcing the stopper 208 against the exterior surface of the elongate member 102. The stopper 208 may be formed of a material that, when forced against the exterior surface of the elongate member 102, a coefficient of friction (e.g., static friction) sufficient to prevent the second gripping member 106 from moving relative to the elongate member 102 is produced. In some embodiments, the stopper 208 may include a material such as rubber, silicone, or the like or a combination thereof. When the button 110 is engaged by a user, the spring 206 is compressed, causing the lever 202 to rotate about pivot element 204 and lifting the stopper 208 away from the exterior surface of the elongate member 102 (or otherwise reducing the force with which the stopper 208 is pressed against the exterior surface of the elongate member 102). Thus when the button 110 is engaged by the user, the frictional force between the stopper 208 and the exterior surface of the elongate member 102 is removed or reduced, and the second gripping member 106 is moveable relative to the elongate member 102.

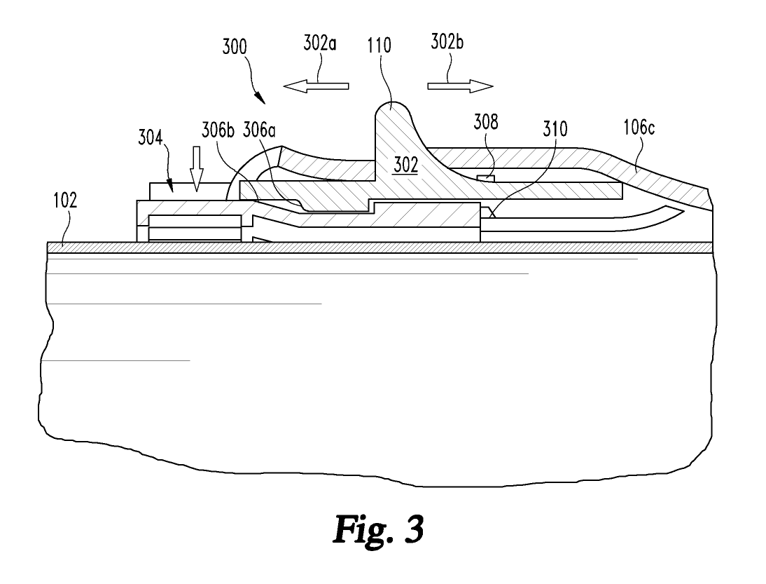

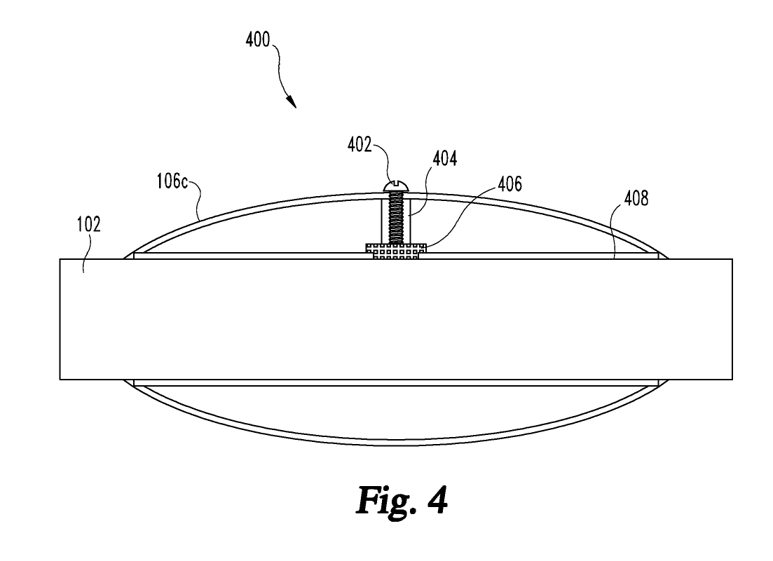

FIGS. 3 and 4 are cross-section views illustrating a selective anchoring mechanism according to some embodiments of the present invention.

Referring to FIG. 3, a selective anchoring mechanism 300 according to another embodiment is disposed within the body 106c of the second gripping member 106. As exemplarily shown, the selective anchoring mechanism 300 includes the aforementioned button 110 as well as a slider 302 and a pawl 304.

As exemplarily illustrated the button 110 can be pushed along the longitudinal direction of the elongate member 102 in the directions indicated by arrows 302a and 302b. The slider 302 is supported within the body 106c by two spaced-apart rails 308 and 310 which are, in turn, coupled to an interior surface of body 106c. The pawl 304 may be held in place within the housing 106c using tabs (shown) that are connected to the interior surface of the body 106c. As the slider 302 is moved in direction 302a, surface 306a of slider 302 is pressed against corresponding surface 306b of pawl 304, forcing pawl 304 against the exterior surface of the elongate member 102. Similar to the stopper 208, the pawl 304 may be formed of a material that, when forced against the exterior surface of the elongate member 102, a coefficient of friction (e.g., static friction) sufficient to prevent the second gripping member 106 from moving relative to the elongate member 102 is produced. Thus, the pawl 304 may include a material such as rubber, silicone, or the like or a combination thereof. When the button 110 is pushed in direction indicated by arrow 302b, the surface 306a on the slider 302 is drawn away from surface 306b on the pawl, and a restoring force within the pawl 304 lifts the pawl 304 away from the exterior surface of the elongate member 102 (or otherwise reduces the force with which the stopper 208 is pressed against the exterior surface of the elongate member 102). Thus when the button 110 is pushed in the direction indicated by arrow 302b, the frictional force between the pawl 304 and the exterior surface of the elongate member 102 is removed or reduced, and the second gripping member 106 is moveable relative to the elongate member 102.

Referring to FIG. 4, a selective anchoring mechanism 400 according to another embodiment is disposed within the body 106c of the second gripping member 106. As exemplarily shown, the selective anchoring mechanism 400 includes a screw 402, a threaded screw guide 404 coupled to an interior surface of the housing 106c, a stopper 406 and sleeve 408 coupled to the housing 106c and supporting the stopper 406. As illustrated, sleeve 408 includes an opening in which a portion of the stopper 406 is located. As the screw 402 is tightened within the threaded screw guide 404, the screw 402 presses against the stopper 406 and forces the stopper 406 against the exterior surface of the elongate member 102. The stopper 406 may be formed of the same type of material as the aforementioned stopper 208. Accordingly, when the screw 402 is sufficiently tightened within the threaded screw guide 404, the second gripping member 106 is immovably coupled to the elongate member 102. But when the screw 402 is loosened within the threaded screw guide 404, the second gripping member 106 is movable relative to the elongate member 102.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An ergonomic apparatus comprising:
a rod having a first end and a second end;
a first gripping member coupled proximate the first end;
an engagement member coupled to the second end; and
a second gripping member movably coupled to the rod between the first end and the second end.

2. The ergonomic apparatus of claim 1, wherein the first gripping member further comprises a plurality of finger-receiving contours.

3. The ergonomic apparatus of claim 1, wherein the second gripping member further comprises:
a plurality of finger receiving contours; and
a release mechanism structured to disengage the second handle from a stationary position on the rod,
wherein the second gripping member can be moved longitudinally between the first end and the second end, and
wherein the second gripping member can be rotated circumferentially about the rod.

4. The ergonomic apparatus of claim 1, wherein the engagement member further comprises a chamber structured to receive an accessory.

5. The ergonomic apparatus of claim 1, wherein the engagement member further comprises a release mechanism for disengaging the accessory.

6. The ergonomic apparatus of claim 1, further comprising a pivotal offset member coupled to the engagement member, wherein the pivotal offset member provides for a pivotal offset between the accessory and the rod.

7. The ergonomic apparatus of claim 4, wherein the accessory is selected from the group consisting of a paint roller, sponge, edger, foam applicator, texturing applicator, and cloth applicator.

8. The ergonomic apparatus of claim 1, wherein the rod has a variable length.

9. The ergonomic apparatus of claim 1, wherein the engagement member further allows for rotation of an accessory relative to the fixed gripping member.

10. An ergonomic apparatus comprising:
a rod having a first end and a second end;
a first gripping member connected to the first end;
means for coupling an accessory to the second end;
a second gripping member between the first and second end; and
means for adjusting the handle position relative to the rod.

11. Paint pole kit comprising:
a rod;
a first gripping member structured to be coupled to a first end of the rod;
a second gripping member structured to be positioned between the first end and the second end of the rod; and
an engagement member structured to be coupled to a second end of the rod.
